(19) United States
(12) Patent Application Publication
(10) Pub. No.: US 2026/0350364 A1
(43) Pub. Date: Nov. 5, 2026

(54) SYSTEM AND METHOD OF PREDICTING MINERAL CONCENTRATION

(71) Applicant: Utilis Israel Ltd., Rosh Ha'ayin (IL)

(72) Inventors: Lauren GUY, Beer Sheva (IL); Yuval LORIG, Katzir (IL); Inon SHARONY, Beit Berl (IL); Adar AMIT, Kibbutz Barkai (IL)

(73) Assignee: Utilis Israel Ltd., Rosh Ha'ayin (IL)

(21) Appl. No.: 19/099,944

(22) PCT Filed: Aug. 1, 2023
(86) PCT No.: PCT/IL2023/050799

§ 371 Date: Jan. 30, 2025

Related U.S. Application Data
(60) Provisional application No. 63/394,186, filed on Aug. 1, 2022.

(51) Int. Cl. G06N 3/0464; G06N 3/08

(52) U.S. Cl. CPC G06N 3/0464; G06N 3/08

(57) ABSTRACT

The present invention relates to practical application of machine learning technics in exploring Earth's subsurface and revealing possible locations of mineral deposits. The invention is directed to a method of predicting mineral concentration in a terrestrial region, the method including obtaining, from a radar mounted on a moving platform, a RF data element, representing reflections of a RF scan from the terrestrial region, in one or more polarizations; analyzing the RF data element to produce a SAR data structure, wherein the SAR data structure comprises one or more polarization layers, respectively representing the one or more polarizations, and wherein each polarization layer comprises a plurality of patch data elements, representing a respective plurality of sub-regions of the scanned terrestrial region; and applying a ML model on the SAR data structure to predict a value of a mineral concentration bin in at least one sub-region of the scanned terrestrial region.

### CROSS REFERENCE TO RELATED APPLICATIONS

This application claims the benefit of priority of U.S. Provisional Patent Application No. 63/394,186, filed Aug. 1, 2022, entitled “SYSTEM AND METHOD OF PREDICTING MINERAL CONCENTRATION”, which is incorporated herein by reference as if fully set forth herein in its entirety.

### FIELD OF THE INVENTION

The present invention relates generally to geology. More specifically, the present invention relates to practical application of machine learning and artificial intelligence technics in exploring Earth's subsurface and revealing possible locations of mineral deposits using synthetic aperture radars (SAR).

### BACKGROUND OF THE INVENTION

As known, the problem of exploring Earth's subsurface to find mineral deposits constantly remains a research topic. Nowadays, a huge number of approaches regarding to the investigation of Earth's subsurface has been developed. Such approaches involve different kinds of drilling technology, geological survey, geochemical and geophysical exploration, and remote sensing.

Remote sensing is a process of detecting and monitoring physical characteristics of an area at a distance (typically from satellite, aircraft or a drone). In geological sciences, remote sensing is used as a complementary data acquisition method to support field observation, since it allows mapping of regions' geological characteristics without physical contact with the areas being explored. The “sensing” is carried out via detection of reflected electromagnetic radiation, which may be naturally (e.g., by the Sun) or artificially (e.g., by a radar installed on a satellite or aircraft) induced.

Synthetic-aperture radar (SAR) is known to be one of the most progressive technologies applied for remote sensing. SAR utilizes the motion and doppler effect of the radar antenna over a target region to provide finer spatial resolution than conventional stationary beam-scanning radars. The distance the SAR device travels over a target during the period when the target scene is radiated creates a large synthetic antenna aperture (the size of the antenna), which, in turn, provides a highly detailed analysis with comparatively small physical antennas.

Although SAR technology can potentially provide detailed and scalable investigation and exploration of mineral deposits at a reasonable expenditure, in practice, it turns out to be challenging. Even having detailed SAR analysis data of a scanned terrestrial region, the definition of dependency between particular SAR data features and a presence or absence of particular mineral deposit, not to mention presumable concentration of a mineral, still remains underdeveloped. Consequently, the results of such an analysis are insufficiently effective and reliable.

### SUMMARY OF THE INVENTION

Accordingly, there is a need for a system and method of predicting mineral concentration in particular terrestrial regions, which would increase efficiency and reliability of applying SAR remote sensing technics for mineral deposits exploration purposes.

To overcome the shortcomings of the prior art, the following invention is provided.

In the general aspect, the invention may be directed to a method of predicting mineral concentration in a terrestrial region by at least one processor, the method including obtaining, from a radar mounted on a moving platform, a Radio Frequency (RF) data element, representing reflections of a RF scan from the terrestrial region, in one or more polarizations; analyzing the RF data element to produce a Synthetic Aperture Radar (SAR) data structure, wherein the SAR data structure comprises one or more polarization layers, respectively representing the one or more polarizations, and wherein each polarization layer comprises a plurality of patch data elements, representing a respective plurality of sub-regions of the scanned terrestrial region; and applying a machine-learning (ML) model on the SAR data structure to predict a range values of a mineral concentrations in at least one sub-region of the scanned terrestrial region.

In another general aspect, the invention may be directed to a system for predicting mineral concentration, the system comprising: a non-transitory memory device, wherein modules of instruction code are stored, and at least one processor associated with the memory device, and configured to execute the modules of instruction code, whereupon execution of said modules of instruction code, the at least one processor is configured to obtain, from a radar mounted on a moving platform, a Radio Frequency (RF) data element, representing reflections of a RF scan from the terrestrial region, in one or more polarizations; analyze the RF data element and produce a Synthetic Aperture Radar (SAR) data structure, wherein the SAR data structure comprises one or more polarization layers, respectively representing the one or more polarizations, and wherein each polarization layer comprises a plurality of patch data elements, representing a respective plurality of sub-regions of the scanned terrestrial region; and apply a machine-learning (ML) model on the SAR data structure to predict a value of a mineral concentration bin in at least one sub-region of the scanned terrestrial region.

In some embodiments, each polarization layer comprises data representing at least one of: (a) an amplitude of the RF scan reflections, and (b) a phase of the RF scan reflections.

In some embodiments, the method further includes calculating, based on the RF data element, one or more local incidence angle values, representing local incidence angles of the RF reflections from the plurality of sub-regions; producing a local incidence angle map, representing the calculated local incidence angle values; and further applying the ML model on the local incidence angle map to predict the mineral concentration bin value.

In some embodiments, the method further includes calculating, based on the RF data element, a digital elevation map representing elevation of sub-regions of the scanned terrestrial region; and further applying the ML model on the digital elevation map to predict the mineral concentration bin value.

In some embodiments, the method further includes receiving optical spectrum data element representing a depiction of the scanned terrestrial region in at least one of an infrared (IR) band, a visible spectrum band and an ultraviolet (UV) band; and further applying the ML model on the optical spectrum data element to predict the mineral concentration bin value.

In some embodiments, the ML model includes at least one convolutional neural network (CNN) model, comprising one or more input channels, each configured to receive an input selected from: the one or more polarization layers, the local incidence angle map, the digital elevation map, and the optical spectrum data element.

In some embodiments, the ML model further includes at least one binary classifier model, adapted to receive an output of the CNN model pertaining to at least one sub-region of the scanned terrestrial region; and calculate a probability that the mineral concentration in the at least one sub-region pertains to a range of concentrations, as defined by a specific mineral concentration bin.

In some embodiments, a range of the radio frequency is selected from a list consisting of an X band, a C band, an S band, an L band, and a P band.

In some embodiments, the one or more polarizations are selected from: (i) a Horizontal transmit-Horizontal receive (HH) linear polarization, (ii) a Horizontal transmit—Vertical receive (HV) linear polarization, (iii) a Vertical transmit—Horizontal receive (VH) linear polarization (iv) a Vertical transmit—Vertical receive (VV) linear polarization, (v) a Right-handed transmit—Right-handed receive (RR) circular polarization, (vi) a Right-handed transmit—Left-handed receive (RL) circular polarization, (vii) a Left-handed transmit-Right-handed receive (LR) circular polarization, (viii) a Left-handed transmit—Left-handed receive (LL) circular polarization.

In some embodiments, the method further includes receiving a training dataset including at least one training SAR data structure corresponding to a training terrestrial region; and at least one annotation representing bin values of mineral concentration in the training terrestrial region; and training the ML model based on the training dataset, to predict values of mineral concentration in the training terrestrial region.

In some embodiments, the training dataset further includes a training local incidence angle map, corresponding to the training terrestrial region.

In some embodiments, the training dataset further includes a training digital elevation map, corresponding to the training terrestrial region.

In some embodiments, the training dataset further includes a training optical spectrum data element, depicting at least a portion of the training terrestrial region.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in the system for predicting mineral concentration according to some embodiments.

FIG. 2A is a block diagram, depicting a system for predicting mineral concentration, according to some embodiments;

FIG. 2B is a block diagram, depicting aspects of training an ML model of the system for predicting mineral concentration, according to some embodiments; and

FIG. 3 is a flow diagram, depicting a method of predicting mineral concentration, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

In the context of the description of the claimed invention, the term “concentration bin” is referred to a “range of concentration values”, accordingly, these terms can be used interchangeably.

In the context of the description of the claimed invention, “a prediction of a mineral concentration in a terrestrial region” may be referred to “a prediction of a mineral concentration in a top level and a subsurface of a terrestrial region”.

In some embodiments of the present invention, ML model may be an artificial neural network (ANN).

A neural network (NN) or an artificial neural network (ANN), e.g., a neural network implementing a machine learning (ML) or artificial intelligence (AI) function, may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g., CPUs or graphics processing units (GPUs), or a dedicated hardware device may perform the relevant calculations.

It should be obvious for the one ordinarily skilled in the art that various ML models can be implemented without departing from the essence of the present invention. It should also be understood, that in some embodiments ML model may be a single ML model or a set (ensemble) of ML models realizing as a whole the same function as a single one. Hence, in view of the scope of the present invention, the abovementioned variants should be considered equivalent.

In some respects, the following description of the claimed invention is provided in accordance with the task of revealing locations of Lithium deposits (e.g., Lithium Carbonate, Lithium Oxides etc.) or any other minerals such as other metal deposits. Such a specific embodiment is provided in order for the description to be sufficiently illustrative and it is not intended to limit the scope of protection claimed by the invention. It should be understood for the one ordinary skilled in the art that the implementation of the claimed invention in accordance with such a task is provided as a non-exclusive example and other practical implementations can be covered by the claimed invention.

As known, artificial intelligence and machine learning technics are very helpful in solving tasks where the connection and dependency between the input data and target output data is complex and uncertain at least for a human to define clearly. Accordingly, the suggested invention incorporates a combination of specific ML and SAR technics, as further described in detail herein. Such a combination is claimed to be effective for predicting mineral concentration in particular terrestrial regions. Such a combination supports the achievement of an improved technical effect of increasing efficiency and reliability of applying SAR remote sensing technics for mineral deposits exploration purposes. The claimed technical effect has been additionally proved during practical implementation of the invention.

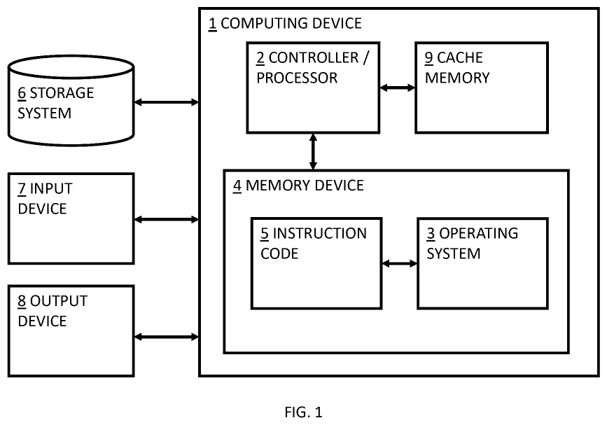

Reference is now made to FIG. 1, which is a block diagram depicting a computing device, which may be included within an embodiment of a system for predicting mineral concentration, according to some embodiments.

Computing device 1 may include a processor or controller 2 that may be, for example, a central processing unit (CPU) processor, a chip or any suitable computing or computational device, an operating system 3, a memory device 4, instruction code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to instruction code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory device 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory device 4 may be or may include a plurality of possibly different memory units. Memory device 4 may be a computer or processor non-transitory readable medium, or a computer non-transitory storage medium, e.g., a RAM. In one embodiment, a non-transitory storage medium such as memory device 4, a hard disk drive, another storage device, etc. may store instructions or code which when executed by a processor may cause the processor to carry out methods as described herein.

Instruction code 5 may be any executable code, e.g., an application, a program, a process, task, or script. Instruction code 5 may be executed by processor or controller 2 possibly under control of operating system 3. For example, instruction code 5 may be an application that may predict mineral concentration by applying ML model on a SAR data structure as further described herein. Although, for the sake of clarity, a single item of instruction code 5 is shown in FIG. 1, a system according to some embodiments of the invention may include a plurality of executable code segments or modules similar to instruction code 5 that may be loaded into memory device 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Various types of input and output data may be stored in storage system 6 and may be loaded from storage system 6 into memory device 4 where it may be processed by processor or controller 2. In some embodiments, some of the components shown in FIG. 1 may be omitted. For example, memory device 4 may be a non-volatile memory having the storage capacity of storage system 6. Accordingly, although shown as a separate component, storage system 6 may be embedded or included in memory device 4.

Cache memory 9 may be or may include for example, a Layer 1 (L1) cache module, a Layer 2 (L2) cache module and/or a Layer 3 (L3) cache memory module, as known in the art. Cache memory 9 may include, for example, an instruction cache memory space and/or a data cache memory space, and may be configured to cooperate with one or more processors (such as element 2) and/or one or more processing cores to execute at least one method according to embodiments of the present invention. Cache memory 9 may typically be implemented on the same die or chip as processor 2 and may thus be characterized by a memory bandwidth that may be higher than that of memory device 4 and storage system 6.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

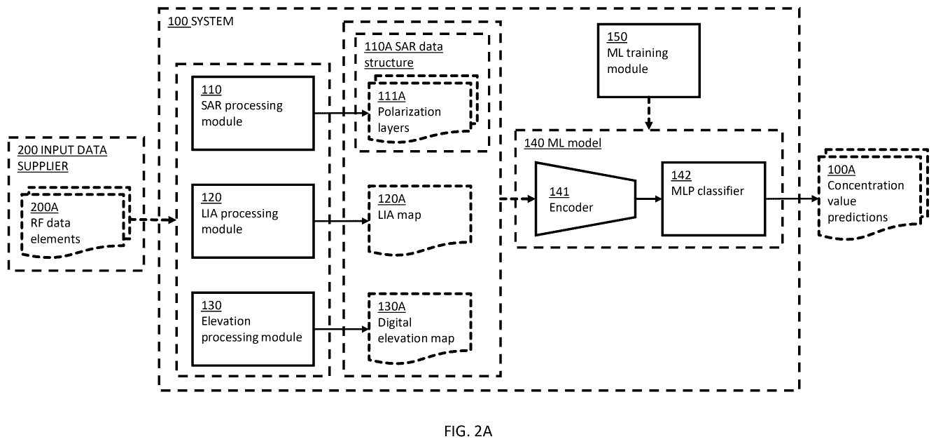

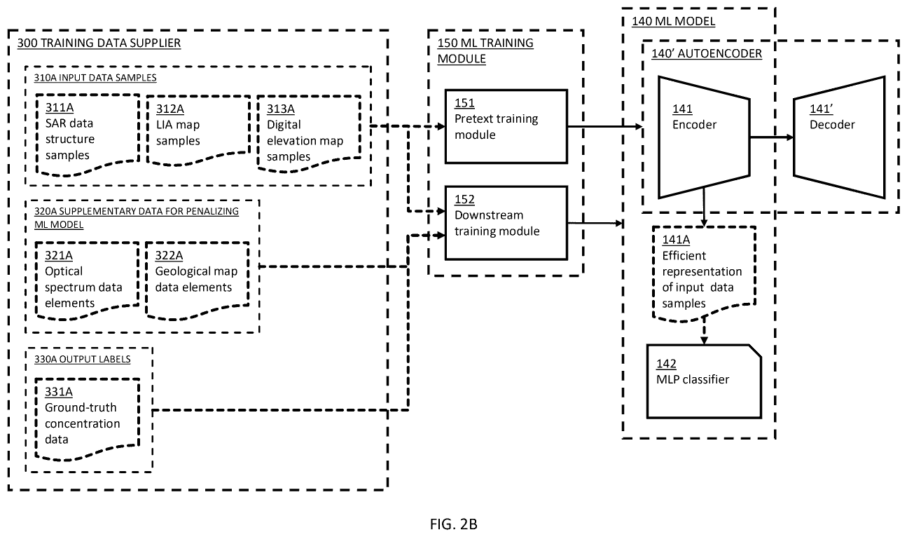

Reference is now made to FIG. 2A, which depicts the system 100 for predicting mineral concentration, according to some embodiments.

According to some embodiments of the invention, system 100 may be implemented as a software module, a hardware module, or any combination thereof. For example, system 100 may be or may include a computing device such as element 1 of FIG. 1. Furthermore, system 100 may be adapted to execute one or more modules of instruction code (e.g., element 5 of FIG. 1) to request, receive, analyze, calculate and produce various data in order to predict, by ML model 140, a value of a mineral concentration bin in sub-regions of the scanned terrestrial region, as further described in detail herein.

As shown in FIGS. 2A and 2B, arrows may represent flow of one or more data elements to and from system 100 and/or among modules or elements of system 100. Some arrows have been omitted in FIGS. 2A and 2B for the purpose of clarity.

In some embodiments, system 100 may include synthetic aperture radar (SAR) processing module 110. In some embodiments, SAR processing module 110 may be configured to obtain, from a radar mounted on a moving platform, a Radio Frequency (RF) data elements 200A, representing reflections of a RF scan from the terrestrial region, in one or more polarizations. Alternatively, RF data elements 200A may be provided by third-party input data supplier (e.g., input data supplier 200), for instance, via network connection.

As known, chemical compounds may include, in a nonlimiting example, Lithium, such as Lithium Carbonate, Lithium Oxides, and others, have a rotational absorption spectrum in the microwave band. Therefore, in order to reliably detect these materials and quantify their abundance, in some embodiments, a range of the radio frequency that is used for scanning is selected from a list consisting of an X band, a C band, an S band, an L band and a P band.

In some embodiments, SAR processing module 110 may be further configured to analyze each RF data element 200A to produce a SAR data structure 110A. In order to increase reliability of predictions further made by ML model 140, SAR processing module 110 may be configured to include into SAR data structure, which is further used as an input for the ML model 140, one or more polarization layers 111A, respectively representing the one or more polarizations. SAR processing module 110 may be configured to select the one or more polarizations from: (i) a Horizontal transmit—Horizontal receive (HH) linear polarization, (ii) a Horizontal transmit—Vertical receive (HV) linear polarization, (iii) a Vertical transmit—Horizontal receive (VH) linear polarization (iv) a Vertical transmit—Vertical receive (VV) linear polarization, (v) a Right-handed transmit—Right-handed receive (RR) circular polarization, (vi) a Right-handed transmit—Left-handed receive (RL) circular polarization, (vii) a Left-handed transmit—Right-handed receive (LR) circular polarization, (viii) a Left-handed transmit—Left-handed receive (LL) circular polarization. SAR processing module 110 may be configured to include into each polarization layer 111A a plurality of patch data elements, representing a respective plurality of sub-regions of the scanned terrestrial region.

Since a reflected wave function of RF scan is generally complex, in order to make the further applying of ML model 140 effectively providing reliable predictions, SAR processing module 110 may be configured to transform wave function to an amplitude component and a phase-difference component. Accordingly, in some embodiments, SAR processing module 110 may be configured to include, into each polarization layer 111A, data representing at least one of an amplitude of the RF scan reflections and phase of the RF scan reflections. In some embodiments, system 100 may be configured to use polarization layers 111A which include data representing an amplitude of the RF scan reflections and polarization layers 111A which include data representing a phase of the RF scan reflections as separate input channels of the ML model 140.

In order to perform the task of finding locations of mineral deposits, various types of data may turn out to be helpful. Therefore, system 100 may be configured to perform data enhancement, i.e., system 100 may be configured to receive, calculate and produce various types of data, in order to further use these data as input channels of the ML model 140, either separately from SAR data structure 110A or as an additional data of each patch data element correspondently. ML model 140, in turn, may be further configured to perform the function of data fusion (or concatenation), combining data from different input channels. Supplementation of ML model 140 input with such data may enhance operation of system 100 since these data may include deeply concealed features, which may be highly relevant to the target output data-mineral concentration value predictions 100A. Moreover, fusion of several data sources and data collection methods using a sufficiently refined system 100 in general, and ML model 140 in particular, may increase the system's robustness to the deficiencies of any single one of those data sources, data types or collection methods. Consequently, supplying additional input channels will amplify the technical effect of increasing efficiency of ML model 140 operation and reliability of ML model 140 predictions. Embodiments of system 100 which include such an enhancement are further described in detail herein.

In some embodiments, system 100 may include local incidence angle (LIA) processing module 120. In the context of the description of the claimed invention, the term “Local Incidence Angle” is referred to an angle between the normal to the ground at a specific location and an angle at which the satellite receives reflected signal.

LIA processing module 120 may be configured to obtain RF data elements 200A provided by input data supplier 200, for instance, via network connection. LIA processing module 120 may be further configured to calculate, based on the RF data elements 200A, one or more local incidence angle values, representing local incidence angles of the RF reflections from the plurality of sub-regions. LIA processing module 120 may be further configured to produce LIA map 120A, representing the calculated local incidence angle values.

In some embodiments, system 100 may include elevation processing module 130. Elevation processing module 130 may be configured to obtain RF data elements 200A provided by input data supplier 200, for instance, via network connection. Elevation processing module 130 may be configured to calculate, based on the RF data elements 200A, digital elevation map 130A representing elevation of sub-regions of the scanned terrestrial region.

Furthermore, supplementary data pertaining to different domains (e.g., optical spectrum data, geological maps etc.) may be used to improve training of ML model 140. The aspects of training are discussed with reference to FIG. 2B further below.

Additionally or alternatively, in some embodiments, system 100 may be configured to receive, at the inference stage, optical spectrum data elements (not shown in FIG. 2A) representing a depiction of the scanned terrestrial region in at least one of an infrared (IR) band, a visible spectrum band and an ultraviolet (UV) band. Said optical spectrum data elements may be provided by a third-party data supplier.

Embodiments described herein provide a non-exclusive list of data types that may be used as input channels of the ML model 100. For example, additionally or alternatively, in some embodiments, system 100 may be configured to receive digital geological maps representing Earth's fault lines and use received geological maps, with respect to the scanned terrestrial region, as additional input channel of the ML model 100.

In some embodiments, system 100 may be further configured to apply ML model 140 on SAR data structure 110A, LIA map 120A, and digital elevation map 130A (and, optionally, optical spectrum data elements and geological map data elements) to predict a value of a mineral concentration bin in at least one sub-region of the scanned terrestrial region and produce concentration value predictions 100A.

In some embodiments, ML model 140 may include convolutional neural network (CNN) model (e.g., CNN-based encoder 141). It shall be understood that, according to some embodiments of the present invention, CNN model may be implemented as an encoder (e.g., encoder 141), therefore, terms “CNN model”, “CNN-based model”, “CNN-based encoder” and “encoder” may refer to the same element and may be used herein interchangeably. Encoder 141 may include one or more input channels, each configured to receive an input selected from: one or more polarization layers 111A, LIA map 120A, and digital elevation map 130A, and, additionally or alternatively, perform a concatenation of said data received from different input channels. Encoder 141 may be further configured to perform a plurality of convolution operations with respect to each of the input channels and to produce feature map-an efficient input data representation-as an output data. Encoder 141 may include convolutional blocks employing batch normalization layer, which were found to provide superior accuracy than max pooling layers. In addition, system 100 may be configured to concatenate encoder 141 output data with scalar features, e.g., orbit parameters, such as whether the orbit direction is ascending or descending relative to the North pole, and whether the side-looking sensor of the satellite was left-or right-looking during scanning. In some additional or alternative embodiments (not shown in figures), a plurality of ML models 140 may be used, including multiple permutations of ML model 140 (e.g., having different hyperparameters settings, different types of architectures etc.), and system 100 may use such scalar features, e.g., in a decision tree model, to select which encoder 141 to apply.

In some embodiments, ML model 140 may include a single multiclass classifier model or a respective plurality of binary classifier models, e.g., multilayer perceptron (MLP) classifier 142. MLP classifier 142 may be adapted to receive an output of encoder 141 pertaining to at least one sub-region of the scanned terrestrial region. MLP classifier 142 may be further configured to calculate a probability that the mineral concentration in the at least one sub-region pertains to a range of concentrations, as defined by a specific mineral concentration bin (e.g., output concentration value predictions 100A).

In some embodiments, system 100 may be configured to predict average mineral concentration (e.g., average Lithium concentration) pertaining to the various amounts. E.g., in some embodiments, ML model 140 includes k−1 MLP classifiers 142, where k is the number of ranges (bins), that is in provided embodiment k=7. Each MLP classifier 142 may be configured to predict whether the average Lithium concentration in the at least one sub-region (at the location of a given pixel) is higher than the particular preset values of concentration bin. System 100 may be further configured to combine the outputs of MLP classifiers 142 to achieve a resulting probability of a given sub-region pertaining to each of preset concentration bins. For each MLP classifier 142, concentration value may be calculated as follows:
for MLP classifier 142 of the first bin:

P₁=1−Pr(Target>V₁);
for MLP classifiers 142 of the middle bins:

Pᵢ=Pr(Target>Vᵢ)−Pr(Target>Vᵢ₋₁); and
for MLP classifier 142 of the last bin:

Pₖ=Pr(Target>Vₖ₋₁),
wherein Pᵢ is a calculated probability of whether a concentration value pertains to preset concentration bin of particular MLP classifier 142, Pr is a probability of a concentration value V being less than a preset Target value of particular concentration bin.

Further, in order to achieve resulting concentration value prediction 100A, system 100 may be configured to apply estimated likelihood provided by each of the MLP classifiers 142. For example, system 100 may be configured to sort the outputs of MLP classifiers 142 by their estimated likelihood in decreasing order and use the output of MLP classifier 142 having the highest estimated likelihood as the resulting concentration value prediction 100A.

In some embodiments, system 100 may be additionally configured to perform training of ML model 140. The aspects of training ML model 140 are further discussed with reference to FIG. 2B.

Reference is now made to FIG. 2B, which depicts the aspects of training ML model 140 of system 100 for predicting mineral concentration, according to some embodiments.

In some embodiments, system 100 may be configured to receive all required training data (detailed below) from one or more training data suppliers (e.g., training data supplier 300).

In some embodiments, said training data may include input data samples 310A, supplementary data 320A for penalizing ML model 140 (provided in additional or alternative embodiments) and output labels 330A (corresponding to input data samples 310A). Input data samples 310A may include training SAR data structure samples 311A, training LIA map samples 312A, and training digital elevation map samples 313A.

Supplementary data 320A may include optical spectrum data elements 321A and geological map data elements 322A. Geological map data elements 322A may represent digital geological maps of Earth's fault lines, geological units, rock types, unit age, and geomorphological features. Optical spectrum data elements 321A may represent a depiction of the scanned terrestrial region in at least one of an infrared (IR) band, and a visible spectrum band and an ultraviolet (UV) band.

Output labels 330A may include ground-truth concentration data 331A, which may include a plurality of annotations representing bin values of mineral concentration in the training terrestrial region. Ground-truth concentration data 331A may be created mainly by measuring Lithium concentrations in a plurality of drilling holes, at different depths ranging, for example, from 0.5 meters to 10 meters.

In some additional or alternative embodiments, system 100 may include training data preparation module (not shown in figures). Said training data preparation module may be configured to receive ground-truth concentration data 331A.

Training data preparation module may be further configured to request SAR processing module 110, LIA processing module 120 and elevation processing module 130 to provide input training data samples 310A, including SAR data structure samples 311A, training LIA map data samples 312A; and training digital elevation map data samples 313A respectively, corresponding to the training terrestrial region (as indicated in ground-truth concentration data 331A). SAR processing module 110, LIA processing module 120 and elevation processing module 130 may be configured to request for respective RF data elements 200A from input data supplier 200, corresponding to the training terrestrial region. SAR processing module 110, LIA processing module 120 and elevation processing module 130 may be further configured to calculate training SAR data structure samples 311A, training LIA map data samples 312A and training digital elevation map data samples 313A, correspondently, based on received RF data elements 200A.

In some embodiments, additionally or alternatively, said training data preparation module may be further configured to request training data supplier 300 for optical spectrum data elements 321A and geological map data elements 322A, corresponding to the training terrestrial region, and to receive requested data elements 321A and 322A.

The training data preparation module may be further configured to form a training dataset including input data samples 310A, supplementary data 320A for penalizing ML model 140 and output labels 330A, corresponding to the training terrestrial region.

In some embodiments, forming the training dataset may include the following procedures.

The training data preparation module may be configured to produce, based on ground-truth concentration data 331A, an image of training terrestrial region, wherein pixels are sampled into polygons of equal concentration bins such that all the image of training terrestrial region is covered. The training data preparation module may be configured to perform dilation operation around each pixel to form a plurality of square patch data elements, representing a respective plurality of sub-regions of the scanned terrestrial region. In some embodiments, said training data preparation module may be configured to select and set sizes of patch data elements.

Said training data preparation module may be further configured to collate respective patch data elements from each polarization layers 111A of training SAR data structure samples 311A, and, additionally or alternatively, each of training optical spectrum data elements 321A, training LIA map samples 312A and training digital elevation map samples 313A, to form training dataset with corresponding channels of imagery data. Hence, in the prepared training dataset, each training sample is a patch data element including multi-channel imagery data, centered around a pixel to which ground-truth concentration data 331A is attributed. The training data preparation module may be further configured to sample said training dataset using stratified sampling technics in order to enforce equal representation of each class and, consequently, reduce overfitting. The training data preparation module may be further configured to split said training dataset into a set of training samples and a set of validation samples (e.g., in a ratio of 75/25 % in favor of training samples). In some embodiments, said training data preparation module may be further configured to exclude some sub-regions where ground-truth labels are available of both training and validation sample sets, in order to evaluate model generalizability and robustness to the distribution of the input data.

In some embodiments, system 100 may further include ML training module 150.

In some embodiments, ML training module 150 may be configured to train ML model 140 based on said training dataset to predict values of mineral concentration in the training terrestrial region (e.g., concentration value predictions 100A, as shown in FIG. 2A), using included multi-channel imagery data.

Since some of the target minerals (the ones which concentration may be predicted by system 100, e.g., Lithium) are Rare Earth Elements (REEs), in most cases, there may be only a few examples of significant accumulations in topsoil known. Hence, it appears impossible to create well-balanced dataset for supervised learning of classification task (e.g., dataset having equal or almost equal number of labeled samples for each target class, e.g., classes corresponding to specific concentration bins), which in turn renders training of a reliable MLP classifier by using traditional supervised learning methods almost unattainable. On the other hand, there may be much more SAR imagery data (e.g., SAR data structure samples 311A) of a certain terrestrial region (or subregion thereof) provided as an input, disregarding concentrations of the target mineral in that region.

The present invention provides the following solution to the abovementioned problem. It is suggested herein to perform a two-stage training procedure, wherein the first stage (pretext training) may be directed to the training of encoder 141, and the second stage (downstream training) may be directed to the training of MLP classifier 142.

In some embodiments, ML training module 150 may include pretext training module 151 and downstream training module 152, in order to perform said two-stage procedure of training ML model 140, as described in detail below.

The combined two-stage procedure may be referred as Self-Supervised Learning (SSL). The “pretext” training is an unsupervised stage, and it does not require any knowledge of mineral concentrations. The main purpose of it is to make ML model 140 “understand” the essence of input data (which, e.g., may be a concatenation of SAR data structure samples 311A, LIA map data samples 312A and digital evaluation map data samples 313A) and to be able to construct efficient representation 141A of input data samples 310A, which may, e.g., have a reduced dimensionality but be concentrated on highly essential input data features.

In order to do that, in some embodiments, pretext training module 151 may be configured to: (i) concatenate SAR data structure samples 311A, LIA map data samples 312A and digital evaluation map data samples 313A, thereby obtaining input data samples 310A, and (ii) train autoencoder 140′ model, to reconstruct input data samples 310A. Autoencoder 140′ may be of any architecture commonly known in the art, e.g., it may include encoder 141 and decoder 141′ blocks, and it may be trained using ML methods which may be known to the person skilled in the art. In some embodiments, encoder 141 may be implemented as an encoding CNN-based model. The term “encoder” shall be understood herein in the broadest possible meaning and the present invention is not limited to any specific architecture thereof.

After being sufficiently trained, autoencoder 140′ may be able to reliably reconstruct input data samples 310A and, therefore, in an “information bottleneck” segment of autoencoder 140′ (an output of encoder 141, may also be referred herein as a “representation”), may be able to calculate efficient representation 141A of input data samples 310A. When the training of autoencoder 140′ is considered completed, decoder 141′ portion may no longer be used, neither in further training nor in inference of ML model 140.

At the second training stage (downstream training), the ability to calculate efficient representation 141A, developed at the first training stage, may be utilized for further supervised training of ML model 140, in particular, for training MLP classifier 142.

In some embodiments, downstream training module 152 may be configured to receive input data samples 310A and output labels 330A, which may be based on ground-truth concentration data 331A. Downstream training module 152 may be further configured to perform training of ML-model 140, including: (i) providing input data samples 310A as an input to pretrained encoder 141, (ii) calculating, by encoder 141, efficient representation 141A of input data samples 310A, and (iii) further training MLP classifier to predict values of mineral concentration in the training terrestrial region (e.g., concentration value predictions 100A, as shown in FIG. 2A), based on efficient representation 141A of input data samples 310A and corresponding ground-truth concentration data 331A values (e.g., each sample of efficient representation 141A may correspond to certain terrestrial region (or subregion thereof) and be labeled by corresponding ground-truth concentration data 331A value, measured in that region). Said “downstream” training stage may involve supervised ML methods commonly known in the art.

Hence, in some embodiments, ML model 140 may obtain a configuration, wherein encoder 141 may receive input data (e.g., training input data samples 310A (if referred to the training stage); or inference input data samples including one or more polarization layers 111A, LIA map 120A, and digital elevation map 130A (if referred to the inference stage)) in a multi-channel or concatenated single-channel form; calculate efficient representation 141A of said input data and transfer it downstream to MLP classifier 142, which may receive representation 141A as an input and calculate concentration value predictions 100A as an output.

Hence, the suggested configuration of ML model 140 and the indicated two-stage procedure of training thereof may contribute to the improvement of the prior art by mitigating issue with substantial training data lack, thereby increasing training process efficiency and, consequently, increasing reliability of mineral concentration value (or bin) prediction.

Furthermore, in some additional or alternative embodiments, supplementary data 320A analysis may be involved to further improve training of ML model 140, in particular, by being used as a basis for adjusting penalization of ML model 140 for failing to provide correct concentration prediction.

As is known, the presence of certain mineral accumulations (e.g., Lithium) may be explained as follows. The origin of Lithium is in volcanic activity by which Lithium-rich magma finds its way through the earth's crust via fractures. Once on top of the earth's surface, this lava deposits as volcanic rock such as Pegmatite. The rock undergoes weathering and erosion, and its constituents are transported to accumulation basins, such as Salars (where, e.g., the Lithium accumulates in brines) or Mud-clay sedimentation.

Hence, the following distinct phases may be detected: volcanic deposition, transportation, and accumulation. Each of the phases has associated temporal and spatial scales, which may be employed to improve the training process.

E.g., in some embodiments, training of ML model 140 may be directed to mineral concentration value prediction (e.g., subsurface Lithium concentration in areas of known accumulation), based on the highest currently known spatial resolution of RF data elements 200A (e.g., on the order of L-Band SAR imagery pixels (1-10 meters)). Furthermore, if analyze the characteristic length of normal faults in geological maps, which is the result of the spatial resolution of the underlying geophysical measurements (1-10 kilometers, basically, the lowest spatial resolution), the areas of potential volcanic deposits may be detected. Furthermore, if analyze geomorphology of the watershed/drainage system (at resolution of 10 meters to 1 kilometer), paths of Lithium transportation from the volcanic deposits to areas of accumulation may be detected and evaluated.

Additionally or alternatively, downstream training module 152 may be configured to receive supplementary data 320A for penalizing ML model 140. Downstream training module 152 may be further configured to perform the following: (i) for each specific input data sample 310A, select the corresponding supplementary data 320A sample, representing the same training terrestrial region (or portion/subregion thereof) at the required resolution (as indicated above); (ii) analyze optical spectrum data elements 321A and geological map data elements 322A to determine the areas of potential volcanic deposits; (iii) analyze geological map data elements and, additionally or alternatively, digital evaluation map data elements of samples 313A, to detect paths of potential Lithium transportation from the volcanic deposits; and (iv) determine areas of potential Lithium accumulation in said training terrestrial region (or portion/subregion thereof). Downstream training module 152 may be further configured to perform training of ML model 140 further based on (i) detected areas of potential volcanic deposits, (ii) detected paths of potential Lithium transportation, and (iii) determined areas of potential Lithium accumulation. In particular, downstream training module 152 may be configured to calculate a loss function (e.g., function of the difference between estimated (calculated by ML model 140 during training) and true values (e.g., respective ground-truth concentration data 331A) for Lithium concentration), and adjust the value of the loss function further based on at least one of (i) detected areas of potential volcanic deposits, (ii) detected paths of potential Lithium transportation, and (iii) determined areas of potential Lithium accumulation. For example, downstream training module 152 may penalize ML model 140 more strongly for mistakenly predicting a relatively low Lithium concentration value in the area of a sedimentation basin than otherwise.

In some embodiments, for detection of areas of potential volcanic deposits, downstream training module 152 may be further configured to use data from geological map data elements 322A, such as the primary and secondary rock types in each unit, the range of the unit age, and proximity to normal faults, their length, age, and orientation (e.g., “strike and dip”). In locations where geological maps are unavailable, the required information can also be derived from geophysical measurements including seismic reflectometry, magnetometry, and gravimetry. For detection of potential Lithium transportation paths via the drainage system, downstream training module 152 may be further configured to calculate derivative data from Digital Elevation Model (DEM) samples 322A, including the normalized elevation, slope grade, aspect, and curvature.

Hence, application of such supplementary data 320A may help model 140 to effectively rely on areas which may be considered indicative for high topsoil Lithium concentrations, and which may be congruent with local transport pathways and, going further, even volcanic deposits of origin. Thereby, such elaboration of supplementary data 320A may further improve training process and increase reliability of mineral concentration value predictions (e.g., concentration value prediction 100A).

Additionally or alternatively, in order to penalize errors super-linearly with the error magnitude, in some embodiments, ML training module 150 may be configured to use Cross Entropy with Focal Loss with a gamma parameter of 2 as a loss function during training ML model 140. In order to reduce problems caused by unbalanced training dataset, ML training module 150 may be configured to set an alpha parameter for MLP classifier 142 to equal the inverse of the relative abundance of each class (corresponding to desired outputs of MLP classifier 142).

In some embodiments, ML training module 150 may be configured to utilize ADAM optimizer, and/or Early Stopping, and/or linear Learning Rate scheduling technics while training ML model 140.

In some embodiments, at the training stage, system 100 may include a plurality permutations of ML models 140. In some embodiments, ML training module 150 may be configured to perform hyperparameter tunning of a detection threshold of each MLP classifier 142 of the plurality of ML models 140 in order to yield an optimal threshold with regards to recall and precision of each MLP classifier 142. ML training module 150 may be further configured to perform Neural Architecture Search (NAS) to determine the architecture for ML model 140 or components thereof (e.g., encoder 141 and MLP classifier 142) with maximal predictive performance, minimal memory consumption, minimal model size or inference time (i.e., the time required to obtain a prediction) etc. ML training module 150 may be further configured to select the target ML model 140 of the plurality of permutations of ML models 140, based on the results of NAS procedure.

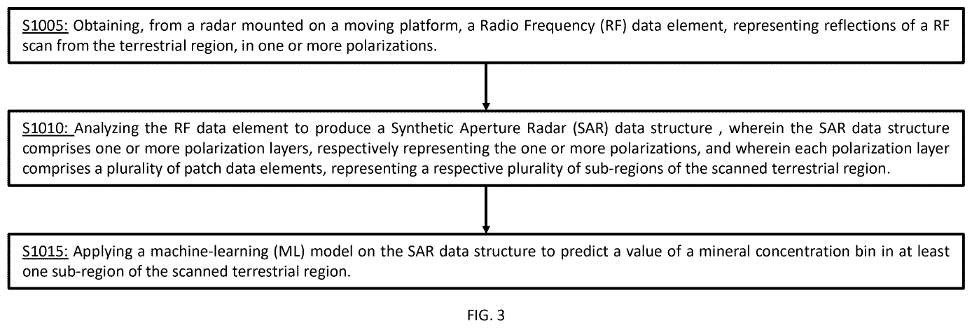

Referring now to FIG. 3, a flow diagram is presented, depicting a method of predicting mineral concentration, by at least one processor, according to some embodiments.

As shown in step S1005, the at least one processor (e.g., processor 2 of FIG. 1) may perform obtaining, from a radar mounted on a moving platform, RF data element 200A, representing reflections of a RF scan from the terrestrial region, in one or more polarizations. Step S1005 may be carried out by SAR processing module 110, LIA processing module 120 and elevation processing module 130 (as described with reference to FIG. 2A).

As shown in step S1010, the at least one processor (e.g., processor 2 of FIG. 1) may perform analyzing RF data element 200A to produce SAR data structure 110A, wherein SAR data structure 110A includes one or more polarization layers 111A, respectively representing the one or more polarizations, and wherein each polarization layer 111A comprises a plurality of patch data elements, representing a respective plurality of sub-regions of the scanned terrestrial region. Step S1010 may be carried out by SAR processing module 110 (as described with reference to FIG. 2A).

As shown in step S1015, the at least one processor (e.g., processor 2 of FIG. 1) may perform applying ML model 140 on SAR data structure 110A to predict a value of a mineral concentration bin (concentration value predictions 100A) in at least one sub-region of the scanned terrestrial region. Step S1015 may be carried out by encoder 141 and MLP classifier 142 (as described with reference to FIG. 2A).

As can be seen from the provided description, the claimed invention represents a system and method of predicting mineral concentration in particular terrestrial regions. The claimed invention increases efficiency and reliability of applying SAR remote sensing technics for mineral deposits exploration purposes.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of predicting mineral concentration in a terrestrial region by at least one processor, the method comprising:
obtaining, from a radar mounted on a moving platform, a Radio Frequency (RF) data element, representing reflections of a RF scan from the terrestrial region, in one or more polarizations;
analyzing the RF data element to produce a Synthetic Aperture Radar (SAR) data structure, wherein the SAR data structure comprises one or more polarization layers, respectively representing the one or more polarizations, and wherein each polarization layer comprises a plurality of patch data elements, representing a respective plurality of sub-regions of the scanned terrestrial region; and
applying a machine-learning (ML) model on the SAR data structure to predict a value of a mineral concentration bin in at least one sub-region of the scanned terrestrial region.

2. The method of claim 1, wherein each polarization layer comprises data representing at least one of: (a) an amplitude of the RF scan reflections, and (b) a phase of the RF scan reflections.

3. The method of claim 1, further comprising:
calculating, based on the RF data element, one or more local incidence angle values, representing local incidence angles of the RF reflections from the plurality of sub-regions;
producing a local incidence angle map, representing the calculated local incidence angle values; and
further applying the ML model on the local incidence angle map to predict the mineral concentration bin value.

4. The method of claim 1, further comprising:
calculating, based on the RF data element, a digital elevation map representing elevation of sub-regions of the scanned terrestrial region; and
further applying the ML model on the digital elevation map to predict the mineral concentration bin value.

5. The method of claim 1, further comprising:
receiving optical spectrum data element representing a depiction of the scanned terrestrial region in at least one of an infrared (IR) band, a visible spectrum band and an ultraviolet (UV) band; and
further applying the ML model on the optical spectrum data element to predict the mineral concentration bin value.

6. The method claim 1, wherein the ML model comprises at least one convolutional neural network (CNN) model, comprising one or more input channels, each configured to receive an input selected from: the one or more polarization layers, the local incidence angle map, the digital elevation map, and the optical spectrum data element.

7. The method of claim 1, wherein the ML model further comprises at least one binary classifier model adapted to:
receive an output of the CNN model pertaining to at least one sub-region of the scanned terrestrial region; and
calculate a probability that the mineral concentration in the at least one sub-region pertains to a range of concentrations, as defined by a specific mineral concentration bin.

8. The method of claim 1, wherein a range of the radio frequency is selected from a list consisting of an X band, a C band, an S band, an L band and a P band.

9. The method of claim 1, wherein the one or more polarizations are selected from: (i) a Horizontal transmit-Horizontal receive (HH) linear polarization, (ii) a Horizontal transmit—Vertical receive (HV) linear polarization, (iii) a Vertical transmit—Horizontal receive (VH) linear polarization (iv) a Vertical transmit—Vertical receive (VV) linear polarization, (v) a Right-handed transmit—Right-handed receive (RR) circular polarization, (vi) a Right-handed transmit—Left-handed receive (RL) circular polarization, (vii) a Left-handed transmit—Right-handed receive (LR) circular polarization, (viii) a Left-handed transmit—Left-handed receive (LL) circular polarization.

10. The method of claim 1, further comprising:
receiving a training dataset comprising:
at least one training SAR data structure corresponding to a training terrestrial region;
and a plurality of annotations representing bin values of mineral concentration in the training terrestrial region; and
training the ML model based on the training dataset, to predict values of mineral concentration in the training terrestrial region.

11. The method of claim 1, wherein the training dataset further comprises a training local incidence angle map, corresponding to the training terrestrial region.

12. The method of claim 1, wherein the training dataset further comprises a training digital elevation map, corresponding to the training terrestrial region.

13. The method of claim 1, wherein the training dataset further comprises a training optical spectrum data element, depicting at least a portion of the training terrestrial region.

14. A system for predicting mineral concentration, the system comprising: a non-transitory memory device, wherein modules of instruction code are stored, and at least one processor associated with the memory device, and configured to execute the modules of instruction code, whereupon execution of said modules of instruction code, the at least one processor is configured to:
obtain, from a radar mounted on a moving platform, a Radio Frequency (RF) data element, representing reflections of a RF scan from the terrestrial region, in one or more polarizations;
analyze the RF data element and produce a Synthetic Aperture Radar (SAR) data structure, wherein the SAR data structure comprises one or more polarization layers, respectively representing the one or more polarizations, and wherein each polarization layer comprises a plurality of patch data elements, representing a respective plurality of sub-regions of the scanned terrestrial region; and
apply a machine-learning (ML) model on the SAR data structure to predict a value of a mineral concentration bin in at least one sub-region of the scanned terrestrial region.

15. The system of claim 14, wherein the at least one processor is configured to:
calculate, based on the RF data element, one or more local incidence angle values, representing local incidence angles of the RF reflections from the plurality of sub-regions;
produce a local incidence angle map, representing the calculated local incidence angle values; and
apply the ML model further on the local incidence angle map, to predict the mineral concentration bin value.

16. The system of claim 14, wherein the at least one processor is configured to:
calculate, based on the RF data element, a digital elevation map representing elevation of sub-regions of the scanned terrestrial region; and
apply the ML model further on the digital elevation map, to predict the mineral concentration bin value.

17. The system of claim 14, wherein the at least one processor is configured to:
receive optical spectrum data element representing a depiction of the scanned terrestrial region in at least one of an infrared (IR) band, a visible spectrum band and an ultraviolet (UV) band; and
apply the ML model further on the optical spectrum data element, to predict the mineral concentration bin value.

18. The system of claim 14, wherein the ML model comprises at least one convolutional neural network (CNN) model, which comprises two or more input channels, wherein each input channel is configured to receive an input selected from: the one or more polarization layers, the local incidence angle map, the digital elevation map, and the optical spectrum data element.

19. The system of claim 14, wherein the ML model further comprises at least one binary classifier model adapted to:
receive an output of the CNN model pertaining to at least one sub-region of the scanned terrestrial region; and
calculate a probability that the mineral concentration in the at least one sub-region pertains to a range of concentrations, as defined by a specific mineral concentration bin.

20. The system of claim 14, wherein the at least one processor is configured to:
receive a training dataset comprising (i) at least one training SAR data structure corresponding to a training terrestrial region, and (ii) a plurality of annotations representing bin values of mineral concentration in the training terrestrial region; and
train the ML model based on the training dataset, to predict values of mineral concentration in the training terrestrial region.
